(19) United States
(12) Patent Application Publication
(10) Pub. No.: US 2019/0287203 A1
(43) Pub. Date: Sep. 19, 2019

(54) METHOD FOR ENHANCING TRANSIT SCHEDULE

(71) Applicant: Clever Devices Ltd., Woodbury, NY (US)

(72) Inventor: Christos KARANICOLAS, Massapequa Park, NY (US)

(73) Assignee: Clever Devices Ltd., Woodbury, NY (US)

(21) Appl. No.: 16/381,098

(22) Filed: Apr. 11, 2019

Related U.S. Application Data
(63) Continuation of application No. 13/704,915, filed on Dec. 17, 2012.
(60) Provisional application No. 61/377,565, filed on Aug. 27, 2010.
(60) Provisional application No. 61/355,866, filed on Jun. 17, 2010.

(51) Int. Cl. G06Q 50/30; G06Q 10/06

(52) U.S. Cl. CPC G06Q 50/30; G06Q 10/06311

(57) ABSTRACT

A method and apparatus are provided for generating an enhanced transit schedule. Schedule deviations are calculated using an existing transit schedule. The schedule deviations are grouped in accordance with a plurality of schedule parameters. A group average deviation is computed for each group of schedule deviations. Each group average deviation is applied to a corresponding set of passing times of the existing transit schedule having corresponding schedule parameters to generate the enhanced transit schedule.

### PRIORITY

This application is a continuation of and claims priority to U.S. application Ser. No. 13/704,915, filed Dec. 17, 2012, and entitled “METHOD FOR ENHANCING TRANSIT SCHEDULE,” which in turn claims priority under 35 U.S.C. §119(e) to U.S. Provisional Patent Application Nos. 61/355,866 and 61/377,565 filed on Jun. 17, 2010 and Aug. 27, 2010, respectively, the disclosures of which are incorporated herein by reference.

### BACKGROUND

### 1. Field of the Invention

The present invention relates generally to the enhancement of a transit schedule, and more particularly, to a method for generating an enhanced transit schedule using an existing transit schedule and a history of variance.

### 2. Description of the Related Art

Public transit is a part of every-day life in many parts of the world and, in particular, urban environments. Commuters rely on transit schedules to plan their trips. Most commuters rely on published, existing, predetermined transit schedules, which do not take into account conditions that may affect the transit schedule such as road work, weather, transit system repair work, street closures, vehicle malfunctions, strikes, and the like. For this reason, such published, static, transit schedules may be considered unreliable.

Attempts that have been made to remedy the above problem include systems for notifying passengers waiting for public transit vehicles of the status of the vehicles, including the arrival times of vehicles at stops. Such systems may work using Global Positioning System (GPS) devices installed on the public transit vehicles. The transit vehicles contain communications devices to relay estimated arrival times to customers waiting at bus stops and the like.

Methods of estimating arrival times can be based on various metrics such as time, date, historical statistics, average speed, current weather, weather forecasts, current traffic and traffic forecasts.

### SUMMARY

The present invention has been made to address at least the above problems and/or disadvantages and to provide at least the advantages described below. Accordingly, an aspect of the present invention provides a method for generating an enhanced transit schedule using an existing transit schedule and a history of variance from that transit schedule.

According to one aspect of the present invention, a method is provided for generating an enhanced transit schedule. Schedule deviations are calculated using an existing transit schedule. The schedule deviations are grouped in accordance with a plurality of schedule parameters. A group average deviation is computed for each group of schedule deviations. Each group average deviation is applied to a corresponding set of passing times of the existing transit schedule having corresponding schedule parameters to generate the enhanced transit schedule.

According to another aspect of the present invention, an apparatus for generating an enhanced transit schedule is provided. The apparatus includes a user input device, and a memory for storing an existing transit schedule and schedule deviations. The apparatus also includes a processor for calculating schedule deviations using the existing transit schedule, grouping the schedule deviations in accordance with a plurality of schedule parameters, computing a group average deviation for each group of schedule deviations, and applying each group average deviation to a corresponding set of passing times of the existing transit schedule having corresponding schedule parameters to generate the enhanced transit schedule. The apparatus further includes a display for displaying at least a portion of the enhanced transit schedule.

### BRIEF DESCRIPTION OF THE FIGURES

The above and other aspects, features and advantages of the present invention will be more apparent from the following detailed description when taken in conjunction with the accompanying drawings, in which:

FIG. 1 is a flowchart illustrating a method of generating an enhanced transit schedule, according to an embodiment of the present invention;

FIG. 2 is a flowchart illustrating the calculation of schedule deviations using an existing transit schedule, according to an embodiment of the present invention;

FIG. 3 is a flowchart illustrating the computation of a group average deviation for each group of schedule deviations, according to an embodiment of the present invention;

FIG. 4 is a graph illustrating a sample exponential moving average weight distribution;

FIG. 5 is a flowchart illustrating the application of each group average deviation to a set of passing times of the existing transit schedule, according to an embodiment of the present invention; and

FIG. 6 is a block diagram illustrating a system for generating an enhanced transit schedule, according to an embodiment of the present invention.

FIG. 7 is a block diagram illustrating a system for generating an enhanced transit schedule, according to an embodiment of the present invention.

FIG. 8 is a block diagram illustrating a system for generating an enhanced transit schedule, according to an embodiment of the present invention.

FIG. 9 is a block diagram illustrating a system for generating an enhanced transit schedule, according to an embodiment of the present invention.

### DETAILED DESCRIPTION OF EMBODIMENTS OF THE PRESENT INVENTION

Preferred embodiments of the present invention are described in detail with reference to the accompanying drawings. Detailed descriptions of constructions or processes known in the art may be omitted to avoid obscuring the subject matter of the present invention. Further, in the following description of the present invention, various specific definitions found in the following description are provided only to provide a general understanding of the present invention, and it is apparent to those skilled in the art that the present invention can be implemented without such definitions.

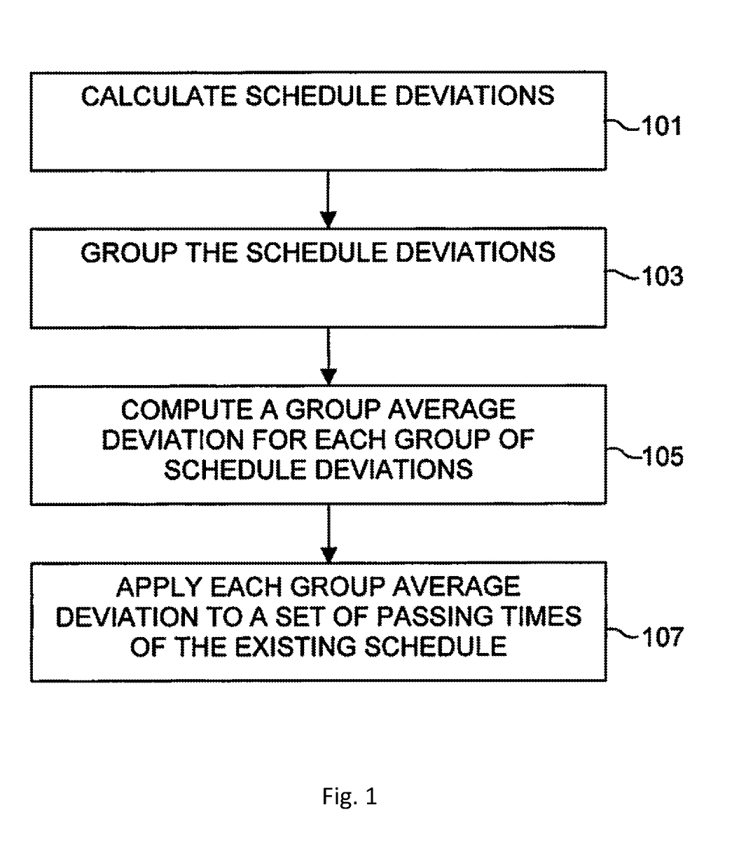

Referring initially to FIG. 1, a flowchart illustrates a method of generating an enhanced transit schedule, according to an embodiment of the present invention. Schedule deviations are calculated using an existing transit schedule in step 101. In an embodiment of the present invention, the existing transit schedule is received from a transit authority. A table of existing transit schedule deviations is shown below in Table 1.

TABLE 1

| | | | | | | On-time | | Early | | |
|---|---|---|---|---|---|---|---|---|---|---|
| | | | | | On- | Avg. | | Avg. | | Late Avg. |
| | | | | | time | Deviation | Early | Deviation | Late | Deviation |
| Date | Hour | Route | Direction | Stop | Count | (s) | Count | (s) | Count | (s) |
| Aug. 2, 2010 | 13 | 20 | Westbound | 456 | 6 | 45 | 3 | −134 | 6 | 356 |
| Aug. 2, 2010 | 14 | 20 | Westbound | 456 | 12 | 120 | 1 | −65 | 0 | 0 |
| Aug. 2, 2010 | 15 | 20 | Westbound | 456 | 10 | 64 | 0 | 0 | 2 | 432 |
| Aug. 2, 2010 | 16 | 20 | Westbound | 456 | 5 | 64 | 5 | −123 | 2 | 385 |
| Aug. 2, 2010 | 17 | 20 | Westbound | 456 | 10 | 105 | 0 | 0 | 2 | 405 |

The schedule deviations are grouped in accordance with a plurality of schedule parameters in step 103. In an embodiment of the present invention, the plurality of schedule parameters includes one or more of a route number, a direction, a stop and a specific time interval. The time interval may be a specific hour of the day. A grouped set of schedule deviations for hour 13 (i.e., between 1:00:00 p.m. and 1:59:59 p.m.), route 20, westbound direction and stop 456 is provided in Table 2 below.

TABLE 2

| | | | | | | On-time | | Early | | |
|---|---|---|---|---|---|---|---|---|---|---|
| | | | | | On- | Avg. | | Avg. | | Late Avg. |
| | | | | | time | Deviation | Early | Deviation | Late | Deviation |
| Date | Hour | Route | Direction | Stop | Count | (s) | Count | (s) | Count | (s) |
| Jul. 3, 2010 | 13 | 20 | Westbound | 456 | 6 | +45 | 3 | −134 | 6 | +356 |
| Jul. 10, 2010 | 13 | 20 | Westbound | 456 | 12 | +120 | 1 | −65 | 0 | 0 |
| Jul. 17, 2010 | 13 | 20 | Westbound | 456 | 10 | +64 | 0 | 0 | 2 | +432 |
| Jul. 24, 2010 | 13 | 20 | Westbound | 456 | 5 | +64 | 5 | −123 | 2 | +385 |
| Jul. 31, 2010 | 13 | 20 | Westbound | 456 | 10 | +105 | 0 | 0 | 2 | +405 |

In an embodiment of the present invention, schedule adherence data for a predetermined number of weekdays is selected when the current transit day begins on a weekday, schedule adherence data for a predetermined number of Saturdays is selected when the current transit day begins on a Saturday, and schedule adherence data for a predetermined number of Sundays is selected when the current transit day begins on a Sunday or a holiday.

Referring again to FIG. 1, group average deviation for each group of schedule deviations is computed in step 105. Each group average deviation is applied to a set of passing times of the existing transit schedule having schedule parameters for a corresponding group of the given group average deviation, to generate the enhanced transit schedule in step 107. The enhanced transit schedule may then be accessed by a user for transmission or display.

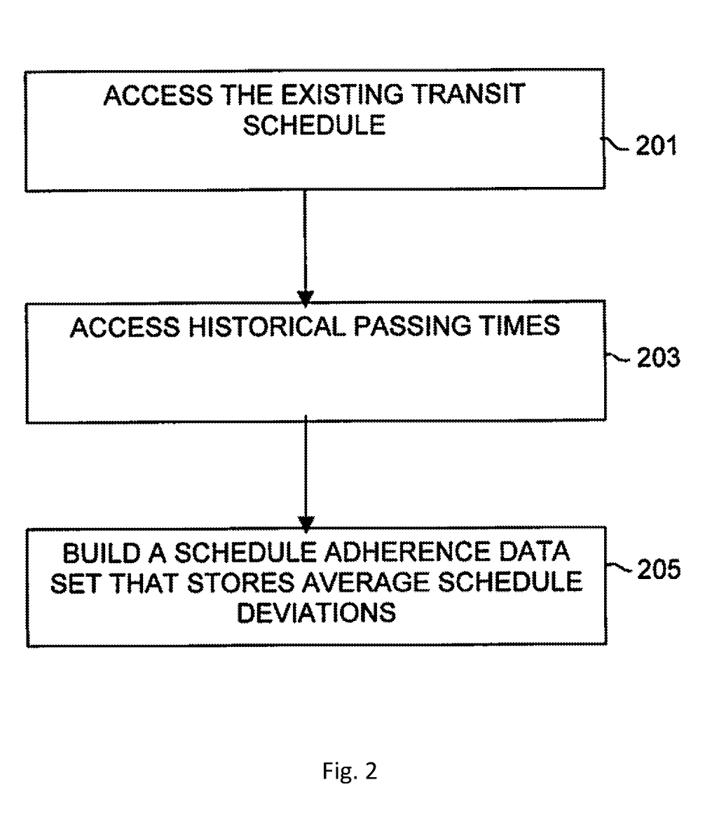

Referring to FIG. 2, a flowchart illustrates the calculation of schedule deviations using an existing transit schedule, according to an embodiment of the present invention. Specifically, FIG. 2 is a detailed description of step 101 in FIG. 1. In step 201, the existing transit schedule is accessed. The existing transit schedule may be a train or a bus schedule, for example. In step 203, historical passing times are accessed. Passing times are times when a stop or other point of interest is passed, or stopped at, by a public transit vehicle. In step 205, a schedule adherence data set that stores average schedule deviations for every route and stop combination is constructed using the existing transit schedule and the historical passing times. In an embodiment of the present invention, the historical passing times are collected by an application in real-time.

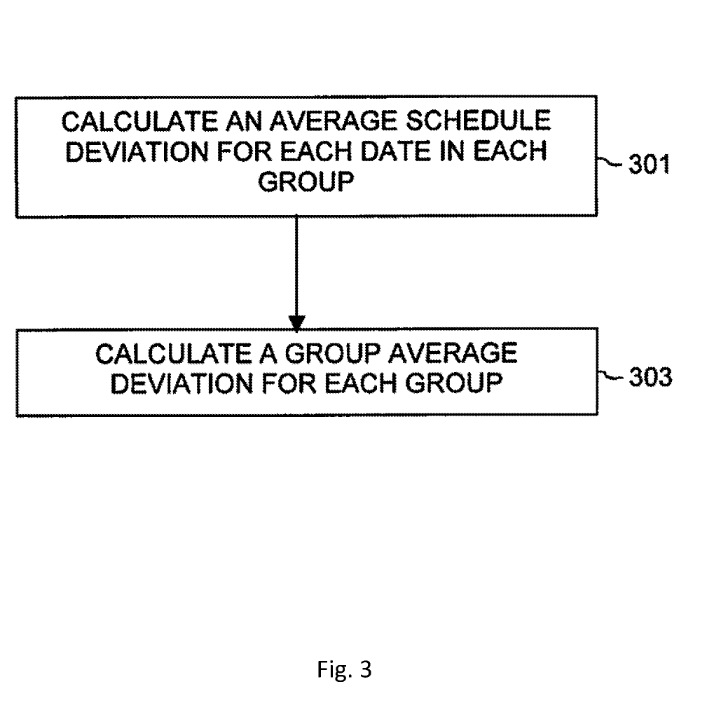

Referring to FIG. 3, a flowchart illustrates the computation of a group average deviation for each group of schedule deviations, according to an embodiment of the present invention. In step 301, an average schedule deviation is calculated for each date in each group (hour 13, route 20, westbound direction, stop 456), as illustrated in Table 3 below.

TABLE 3

| | | | | | | Total |
|---|---|---|---|---|---|---|
| | | | | | | Average |
| | | | | | Total | Schedule |
| Date | Hour | Route | Direction | Stop | Count | Deviation (s) |
| Jul. 3, 2010 | 13 | 20 | Westbound | 456 | 6 | +134 |
| Jul. 10, 2010 | 13 | 20 | Westbound | 456 | 12 | +106 |
| Jul. 17, 2010 | 13 | 20 | Westbound | 456 | 10 | +125 |
| Jul. 24, 2010 | 13 | 20 | Westbound | 456 | 5 | +40 |
| Jul. 31, 2010 | 13 | 20 | Westbound | 456 | 10 | +155 |

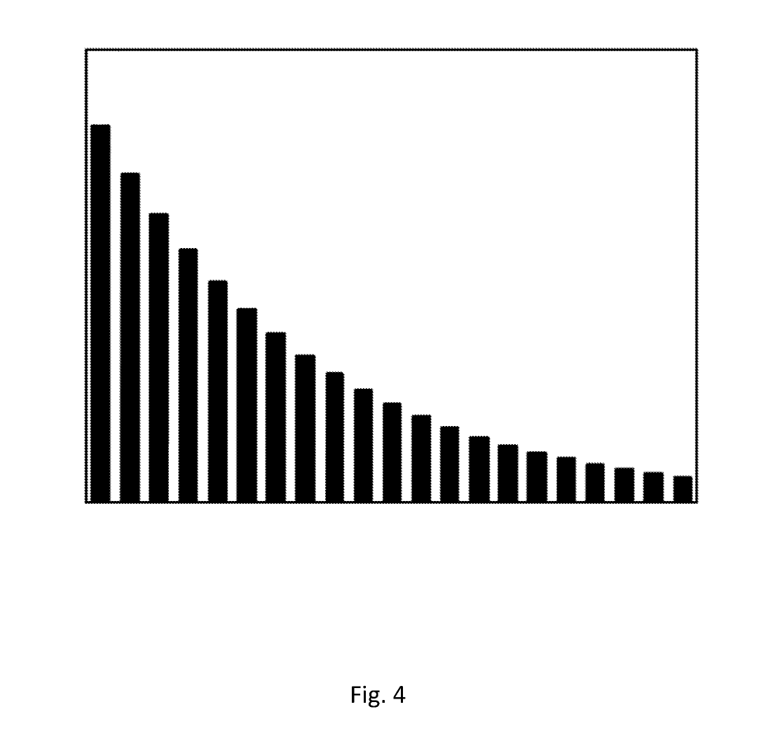

In step 303, a group average deviation is calculated by exponentially weighting the average schedule deviations for each date in that group. A graph illustrating a sample exponential moving average weight distribution is illustrated in FIG. 4. The exponentially weighted average deviation for the group of relevant deviations is calculated to be +65 seconds (i.e., 65 seconds late), as shown in Table 4. In an embodiment of the present invention, the smoothing factor of the exponentially weighted average is a number substantially close to 1. In another embodiment of the present invention, the exponentially weighted average gives more weight to the more recent data.

TABLE 4

| | | | | Exponential |
|---|---|---|---|---|
| | | | | Weighted Average |
| Hour | Route | Direction | Stop | Deviation (s) |
| 13 | 20 | Westbound | 456 | +65 |

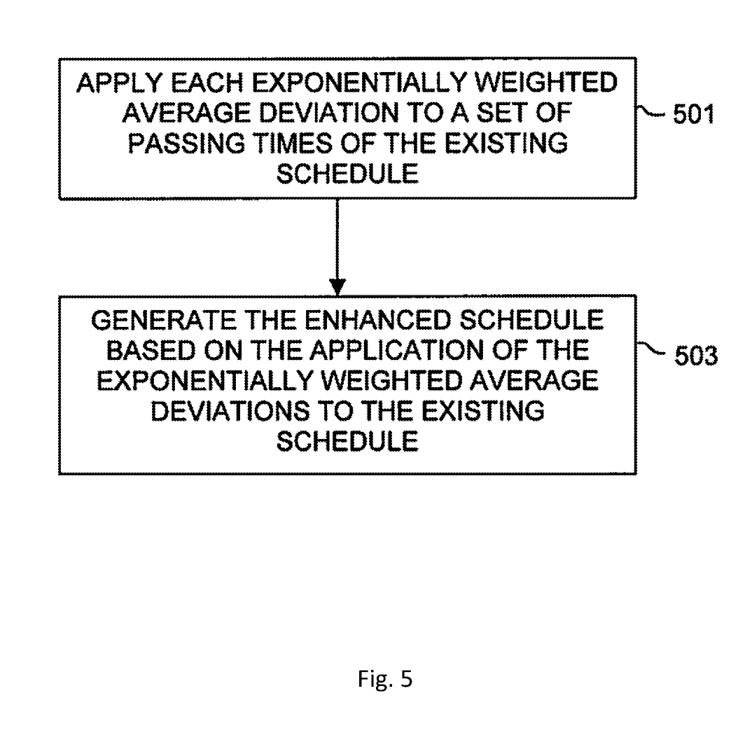

Referring now to FIG. 5, a flowchart illustrates the application of each group average deviation to a set of passing times of the existing transit schedule, according to an embodiment of the present invention. In step 501, an exponentially weighted average deviation, as shown in Table 4, is applied to a set of passing times of the existing transit schedule having corresponding hour, route, direction and stop parameters. Thus, as shown in Table 5 below, the calculated exponential average schedule deviation of 65 seconds is applied to the corresponding passing times of the existing transit schedule for the calculation of enhanced scheduled passing times. In step 503, an enhanced transit schedule is generated based on the application of each of a plurality of exponentially weighted average deviations to a corresponding set of passing times of the existing transit schedule.

TABLE 5

| | | | | Exponential | Enhanced |
|---|---|---|---|---|---|
| | | | | Average | Scheduled |
| | | | Scheduled | Schedule | Passing |
| Route | Direction | Stop | Passing Time | Deviation (s) | Time |
| 20 | Westbound | 456 | 1:00:28 PM | +65 | 1:01:33 PM |
| 20 | Westbound | 456 | 1:13:28 PM | +65 | 1:14:33 PM |
| 20 | Westbound | 456 | 1:26:53 PM | +65 | 1:27:58 PM |
| 20 | Westbound | 456 | 1:40:17 PM | +65 | 1:41:23 PM |
| 20 | Westbound | 456 | 1:53:17 PM | +65 | 1:54:23 PM |

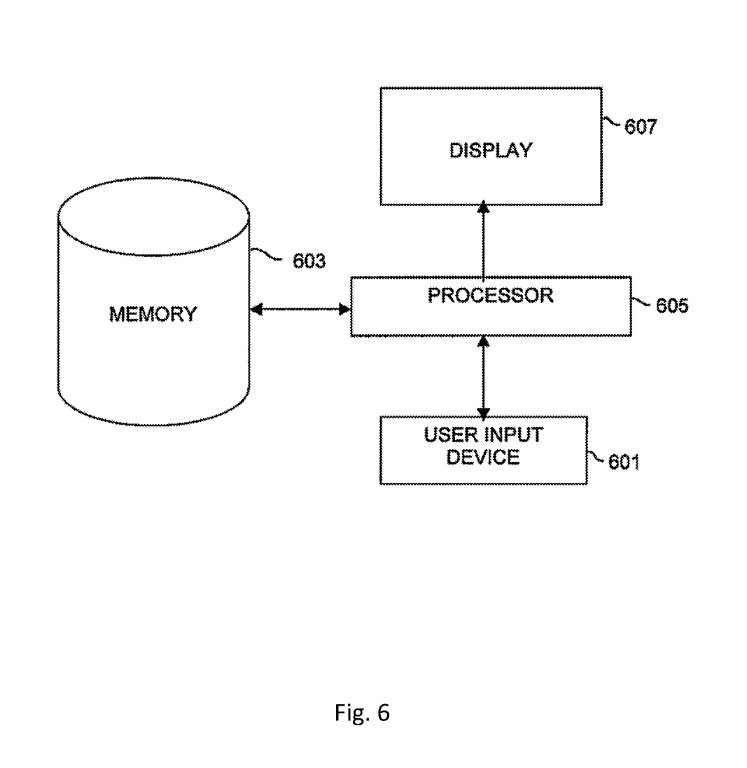

FIG. 6 illustrates an apparatus for generating an enhanced transit schedule, according to an embodiment of the present invention. The apparatus includes a user input device 607 for input of a plurality of schedule parameters, and a memory 603 for storing an existing transit schedule and schedule deviations. The apparatus also includes a processor 605 for calculating schedule deviations using an existing transit schedule, grouping the schedule deviations in accordance with a plurality of schedule parameters, computing a group average deviation for each group of schedule deviations, and applying each group average deviation to a corresponding set of passing times of the existing transit schedule to generate the enhanced transit schedule, as described above. Additionally, the apparatus includes a display 601 for displaying at least a portion of an enhanced transit schedule.

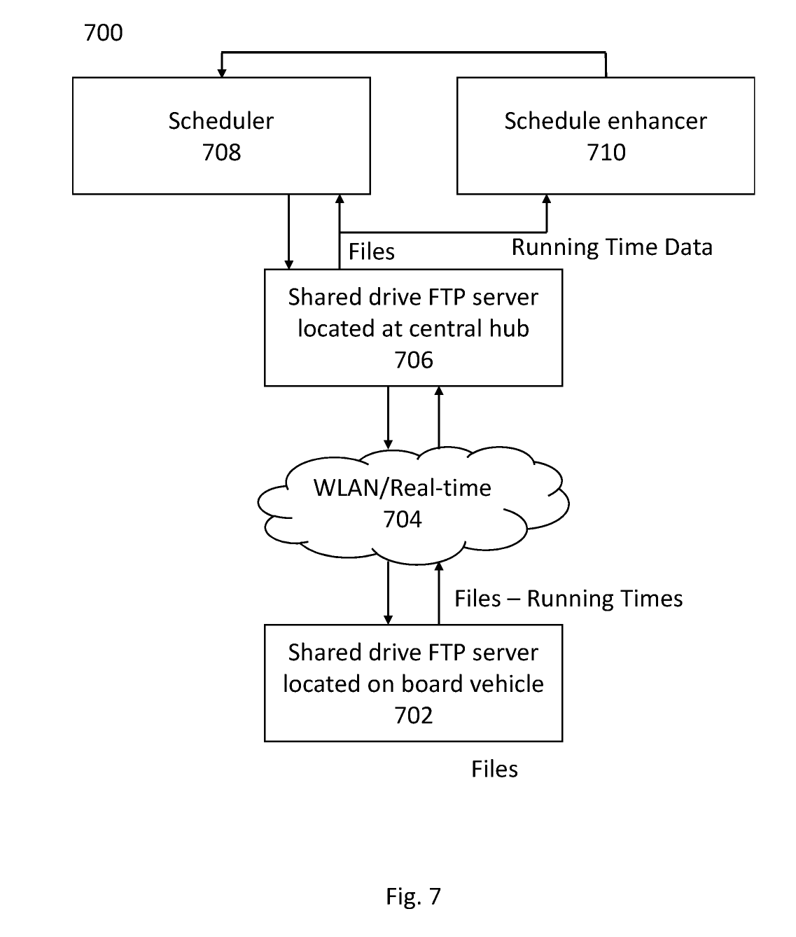

FIG. 7 illustrates a system for generating an enhanced transit schedule 700, according to an embodiment of the present invention. The system may have a shared drive FTP server located on board one or more vehicles 702. This on-board device may collect the actual running times of the vehicle and may then transmit the collected running times, in real-time 704, to a central server, which may be a shared drive FTP server located at a central hub 706. Alternatively, data transfer to the central server may take place at the end of the day, when the vehicle reaches the transit depot.

Data may be transmitted from the central server 706 to a scheduler 708, such as a BUSTIME system. Running time data may be transmitted from a central server 706 to a schedule enhancer 710, which may generate an optimized schedule using the collected running times. The optimized schedule may then be provided to the scheduler 708, where it may be ingested into the passenger information system to generate predicted arrival times for the vehicle.

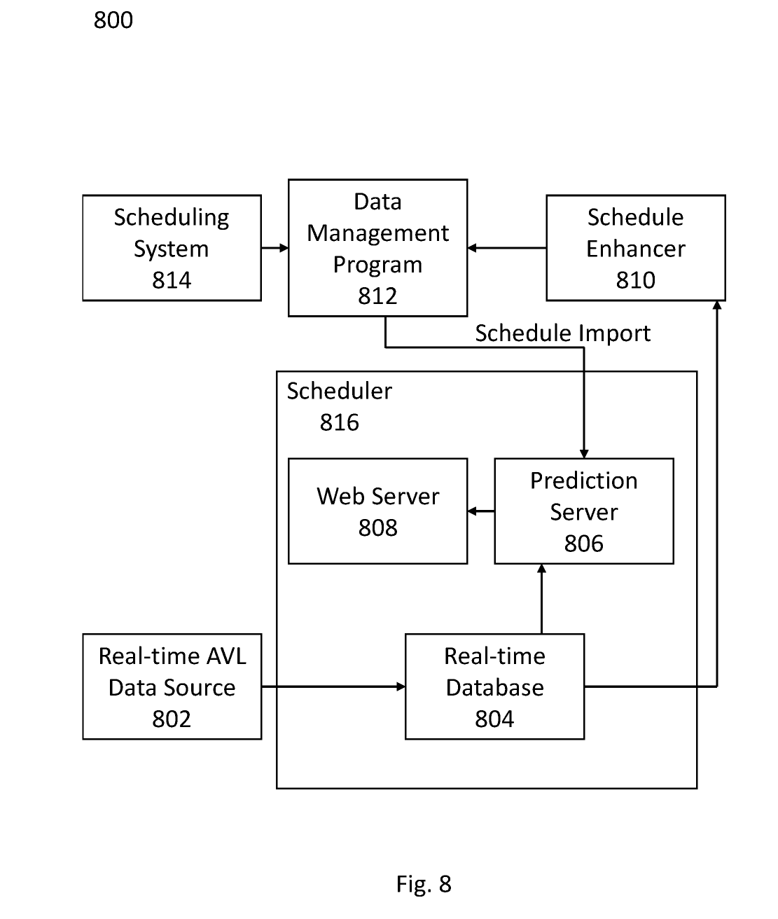

FIG. 8 illustrates a system for generating an enhanced transit schedule 800, according to an embodiment of the present invention. The system may retrieve information from a real-time AVL data source 802, which may be fed into a real-time database 804, provided in the scheduler 816. The real-time database 804 may provide information to a prediction server 806 and to a schedule enhancer 816.

The schedule enhancer 816 may provide an optimized schedule to a data management program 812, which may also retrieve schedule information from a scheduling system 814. The prediction server 806 may import the schedule from the data management program, combine it with real-time information from the real-time database 804, and upload the combined information to a web server 808.

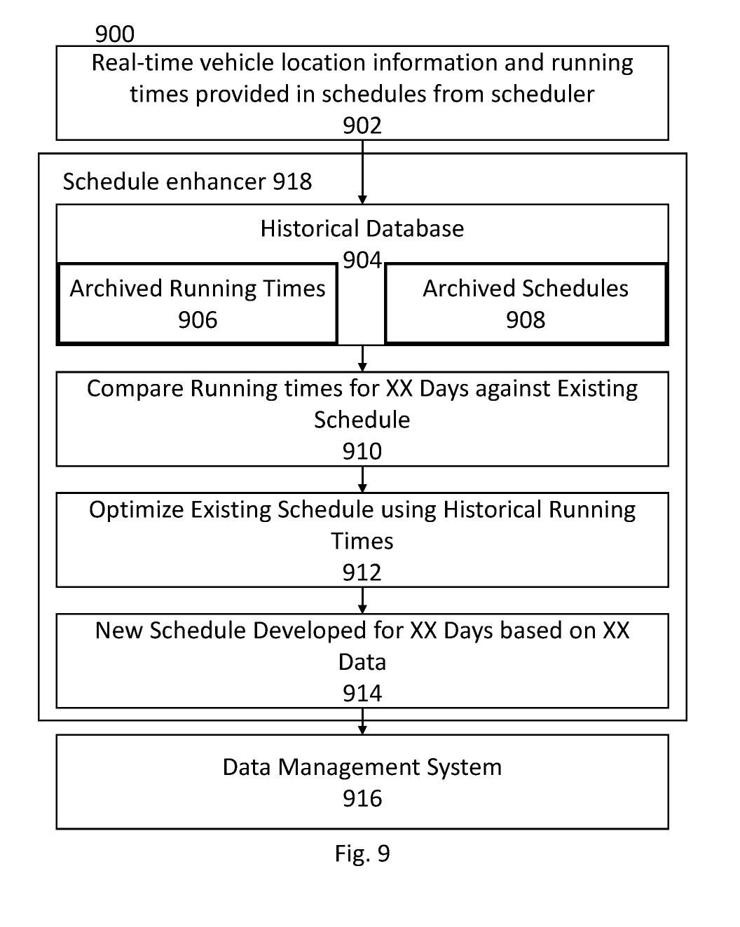

FIG. 9 illustrates a system for operating a schedule enhancer 900, according to an embodiment of the present invention. The scheduler may provide real-time vehicle location information and running times 902 to the schedule enhancer 918. The schedule enhancer 918 may include a historical database 904 including archived running times 906 and archived schedules 908. The schedule enhancer 918 may compare historical running times against the existing schedule 910. The schedule enhancer may then optimize the existing schedule using the historical running times 912. The schedule enhancer 918 may then develop a new schedule for a number of days based on a number of days of historical data 914. This new schedule may then be output to a data management system 916.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A computer program product stored in a computer readable medium for reporting on a collection of scheduling information for a plurality of transit vehicles, comprising:
computer code for collecting positioning information in real-time from the plurality of transit vehicles;
computer code for aggregating the positioning information in a database;
computer code for completing a plurality of predictions by enhancing scheduling information based on past records and based on the positioning information, the process of enhancing the plurality of predictions comprising:
retrieving an existing transit schedule, the existing transit schedule comprising a plurality of entries, each of the plurality of entries comprising a plurality of schedule parameters, the plurality of schedule parameters including at least a route number, a direction, a stop, and scheduled passing time information;
receiving, from the database, arrival time data comprising a plurality of historical passing times;
calculating, using the existing transit schedule and the arrival time data, schedule adherence data comprising a plurality of schedule deviations, each of the plurality of schedule deviations corresponding to a specific entry in the plurality of entries;
storing the plurality of schedule deviations in a memory;
grouping the plurality of schedule deviations into a plurality of groups, wherein grouping the plurality of schedule deviations into a plurality of groups comprises separating each of the plurality of schedule deviations into a group based on the numerical value of said schedule deviation, and wherein the plurality of groups comprises an on-time group of schedule deviations comprising schedule deviations that are substantially zero, an early group of schedule deviations comprising schedule deviations that are substantially negative, and a late group of schedule deviations comprising schedule deviations that are substantially positive;
computing a plurality of group average deviations, each of the plurality of group average deviations corresponding to one of the plurality of groups of schedule deviations;
computing a plurality of exponential weighted average deviations, each exponential weighted average deviation being computed from a plurality of group average deviations;
generating a plurality of adjusted entries by adjusting the scheduled passing time information of each entry in the plurality of entries by said corresponding exponential weighted average distribution; and
generating an enhanced transit schedule comprising a plurality of adjusted entries, and further comprising variance data, the enhanced transit schedule being fixed in value for one or more days; and
computer code for outputting one or more elements of the enhanced transit schedule on a display.

2. The computer program product of claim 1, wherein the computer code for collecting positioning information comprises code for communicating with a shared drive FTP server provided onboard each of the plurality of transit vehicles.

3. The computer program product of claim 1, wherein the positioning information is provided by an automated vehicle location (AVL) system. 4, The computer program product of claim 1, wherein the positioning information is GPS data.

5. The computer program product of claim 1, wherein each entry in the plurality of entries having scheduled passing time information falling within a specific time interval is grouped into an entry group based on said specific time interval.

6. The computer program product of claim 5, wherein grouping the plurality of schedule deviations into a plurality of groups further comprises, for each entry group, identifying a set of schedule deviations in the plurality of schedule deviations that correspond to entries in said entry group, and grouping said set of schedule deviations.

7. The computer program product of claim 1, further comprising computer code for retrieving, from the database, an archived schedule different from the enhanced transit schedule and one or more archived running times corresponding to the archived schedule, wherein the archived schedule is a previously-implemented transit schedule and wherein the one or more archived running times are observed running times of vehicles operating under the archived schedule; and
generating, using a processor of a prediction server, from the enhanced transit schedule, the archived schedule, and the one or more archived running times, a predicted actual arrival time of a vehicle operating under the enhanced transit schedule.

8. The computer program product of claim 1, wherein grouping the plurality of schedule deviations into a plurality of groups further comprises:
grouping schedule adherence data for a predetermined number of weekdays, when a current transit day begins on a weekday;
grouping schedule adherence data for a predetermined number of Saturdays, when the current transit day begins on a Saturday; and
grouping schedule adherence data for a predetermined number of Sundays, when the current transit day begins on a Sunday or a holiday.

9. The computer program product of claim 1, wherein the enhanced transit schedule variance data comprises a plurality of exponential weighted average deviations, and wherein each of the plurality of adjusted entries is paired with one of the plurality of exponential weighted average deviations.

10. The computer program product of claim 1, further comprising computer code for uploading the enhanced transit schedule to a Web server.

11. A system for providing a time of arrival of a plurality of transit vehicles, comprising:
a plurality of transit vehicles, each of the plurality of transit vehicles equipped with an automated vehicle location (AVL) system and equipped to track a GPS location of the vehicle, each of the plurality of transit vehicles configured to store the GPS location of the vehicle in a shared drive FTP server and communicate the GPS location of the vehicle to a central server;
the central server comprising a processor, a memory, and a network connection, the network connection configured to receive GPS location data from each of the plurality of transit vehicles, the server configured to communicate with a scheduler and with a schedule enhancer via the network connection;
the schedule enhancer comprising a historical database including archived running times for each of the plurality of transit vehicles and archived schedules for each of the plurality of transit vehicles, the schedule enhancer configured to optimize an existing schedule using the archived running times to generate an optimized schedule, wherein optimizing the existing schedule comprises:
retrieving the existing transit schedule, the existing transit schedule comprising a plurality of entries, each of the plurality of entries comprising a plurality of schedule parameters, the plurality of schedule parameters including at least a route number, a direction, a stop, and scheduled passing time information;
retrieving, from the historical database, arrival time data comprising a plurality of archived running times for a particular transit vehicle;
calculating, using the existing transit schedule and the arrival time data, schedule adherence data comprising a plurality of schedule deviations, each of the plurality of schedule deviations corresponding to a specific entry in the plurality of entries;
storing the plurality of schedule deviations in a memory;
grouping the plurality of schedule deviations into a plurality of groups, wherein grouping the plurality of schedule deviations into a plurality of groups comprises separating each of the plurality of schedule deviations into a group based on the numerical value of said schedule deviation, and wherein the plurality of groups comprises an on-time group of schedule deviations comprising schedule deviations that are substantially zero, an early group of schedule deviations comprising schedule deviations that are substantially negative, and a late group of schedule deviations comprising schedule deviations that are substantially positive;
computing a plurality of group average deviations, each of the plurality of group average deviations corresponding to one of the plurality of groups of schedule deviations;
computing a plurality of exponential weighted average deviations, each exponential weighted average deviation being computed from a plurality of group average deviations;
generating a plurality of adjusted entries by adjusting the scheduled passing time information of each entry in the plurality of entries by said corresponding exponential weighted average distribution; and
generating the optimized schedule comprising a plurality of adjusted entries, and further comprising variance data, the optimized schedule being fixed in value for one or more days; and
the scheduler comprising a passenger information system, wherein the passenger information system is configured to generate predicted actual arrival times for the vehicle based on the optimized schedule and the GPS location data, and is further configured to upload said predicted arrival times to a Web server accessible by one or more passengers.

12. The system of claim 11, wherein each entry in the plurality of entries having scheduled passing time information falling within a specific time interval is grouped into an entry group based on said specific time interval.

13. The system of claim 12, wherein grouping the plurality of schedule deviations into a plurality of groups further comprises, for each entry group, identifying a set of schedule deviations in the plurality of schedule deviations that correspond to entries in said entry group, and grouping said set of schedule deviations.

14. The system of claim 11, wherein the system further comprises a display, and wherein the system is further configured to display, on the display, at least one of the predicted actual arrival times.

15. The system of claim 11, wherein grouping the plurality of schedule deviations into a plurality of groups further comprises:
grouping schedule adherence data for a predetermined number of weekdays, when a current transit day begins on a weekday;
grouping schedule adherence data for a predetermined number of Saturdays, when the current transit day begins on a Saturday; and
grouping schedule adherence data for a predetermined number of Sundays, when the current transit day begins on a Sunday or a holiday.

16. The system of claim 11, wherein the enhanced transit schedule variance data comprises a plurality of exponential weighted average deviations, and wherein each of the plurality of adjusted entries is paired with one of the plurality of exponential weighted average deviations.

17. The system of claim 11, wherein each of the plurality of transit vehicles is configured to communicate the GPS location of the vehicle to the central server in real time via a wireless connection.

18. The system of claim 11, wherein each of the plurality of transit vehicles is configured to communicate the GPS location of the vehicle to the central server as batch data via a local connection.

19. The system of claim 18, wherein a communication link to the central server is provided at a transit depot, and wherein each of the plurality of transit vehicles is configured to upload GPS location data of the transit vehicle once the transit vehicle detects that the transit depot has been reached.

20. A method for providing an absolute time of arrival of a plurality of transit vehicles, comprising:
operating a plurality of transit vehicles, each of the plurality of transit vehicles equipped with an automated vehicle location (AVL) system and equipped to track a GPS location of the transit vehicle;
storing, in a shared FTP server located onboard each of the plurality of public transit vehicles, the GPS location of the transit vehicle, and communicating, from the shared FTP server, the GPS location of the transit vehicle to a central server comprising a processor, a memory, and a network connection;
providing, with the central server, running time data comprising archived running times for each of the plurality of transit vehicles and archived schedules for each of the plurality of transit vehicles, to a schedule enhancer;
generating, with the schedule enhancer, an enhanced transit schedule, wherein generating the enhanced transit schedule comprises:
retrieving an existing transit schedule, the existing transit schedule comprising a plurality of entries, each of the plurality of entries comprising a plurality of schedule parameters, the plurality of schedule parameters including at least a route number, a direction, a stop, and scheduled passing time information;
retrieving, from the central server, arrival time data comprising a plurality of archived running times for a particular transit vehicle;
calculating, using the existing transit schedule and the arrival time data, schedule adherence data comprising a plurality of schedule deviations, each of the plurality of schedule deviations corresponding to a specific entry in the plurality of entries;
storing the plurality of schedule deviations in a memory;
grouping the plurality of schedule deviations into a plurality of groups, wherein grouping the plurality of schedule deviations into a plurality of groups comprises separating each of the plurality of schedule deviations into a group based on the numerical value of said schedule deviation, and wherein the plurality of groups comprises an on-time group of schedule deviations comprising schedule deviations that are substantially zero, an early group of schedule deviations comprising schedule deviations that are substantially negative, and a late group of schedule deviations comprising schedule deviations that are substantially positive;
computing a plurality of group average deviations, each of the plurality of group average deviations corresponding to one of the plurality of groups of schedule deviations;
computing a plurality of exponential weighted average deviations, each exponential weighted average deviation being computed from a plurality of group average deviations;
generating a plurality of adjusted entries by adjusting the scheduled passing time information of each entry in the plurality of entries by said corresponding exponential weighted average distribution; and
generating the enhanced transit schedule comprising a plurality of adjusted entries, and further comprising variance data, the enhanced transit schedule being fixed in value for one or more days;
generating, with a scheduler comprising a passenger information system, predicted arrival times for the vehicle based on the enhanced transit schedule and the GPS location data;
uploading said predicted arrival times to a Web server accessible by one or more passengers; and
displaying, on a display, one or more elements of the enhanced transit schedule.
